(19) United States
(12) Patent Application Publication
(10) Pub. No.: US 2018/0178471 A1
(43) Pub. Date: Jun. 28, 2018

(54) TIRE MEMBER EXTRACTION DEVICE AND TIRE MEMBER EXTRACTION METHOD

(71) Applicant: Toyo Tire & Rubber Co., Ltd., Itami-shi (JP)

(72) Inventor: Toshiya Matsuyama, Itami-shi (JP)

(73) Assignee: Toyo Tire & Rubber Co., Ltd., Itami-shi (JP)

(21) Appl. No.: 15/848,923

(22) Filed: Dec. 20, 2017

(30) Foreign Application Priority Data
Dec. 26, 2016 (JP) 2016-251640

(51) Int. Cl. B29D 30/50; B29D 30/00

(52) U.S. Cl. CPC B29D 30/50; B29D 2030/482; B29D 2030/0044; B29D 30/0016

(57) ABSTRACT

A plurality of rollers each having a rotary shaft parallel to a rotary shaft of a rotary support body are moved toward a tire member in a synchronized manner so that the tire member is disposed between the plurality of rollers and the rotary support body while the rollers are brought into contact with at least one of the rotary support body and the tire member supported by the rotating rotary support body and the rotary support body is contracted in a state where the tire member is disposed between the plurality of rollers and the rotary support body so that the tire member is delivered from the rotary support body to the plurality of rollers.

### BACKGROUND OF THE INVENTION

### Field of the Invention

The present invention relates to a tire member extraction device and a tire member extraction method for extracting a ring-shaped tire member supported by an outer peripheral surface of an expandable and contractible rotary support body from the rotary support body.

### Description of the Related Art

In general, tire members such as an inner liner, a side wall portion, a bead portion, and a tread portion are formed in advance in order to manufacture a pneumatic tire. These tire members are bonded to each other in an unvulcanized state to mold a tire member called a cylindrical casing or a green tire. Then, a pneumatic tire is manufactured by vulcanizing and molding the green tire.

There is a case in which these tire members are formed in a ring shape by affixing a reinforcement cord coated with rubber or a rubber member having a predetermined shape onto an outer peripheral surface of a rotary support body while rotating the rotary support body. Then, the formed ring-shaped tire member is extracted by an extraction device disclosed in JP-A-2000-355056 and is conveyed to the next step.

However, in the conventional extraction device, since it is necessary to extract the ring-shaped tire member formed on the rotary support body after the rotation of the rotary support body is stopped, there is room for improvement in shortening the manufacturing time.

### SUMMARY OF THE INVENTION

The invention is made in view of the above-described circumstances and an object of the invention is to provide a tire member extraction device and a tire member extraction method capable of extracting a ring-shaped tire member formed on a rotary support body during the rotation of the rotary support body.

A tire member extraction device of the invention is a tire member extraction device for extracting a ring-shaped tire member supported by an outer peripheral surface of an expandable and contractible rotary support body from the rotary support body, the tire member extraction device including: a plurality of rollers; and a movement mechanism which moves the plurality of rollers toward and away from the tire member supported by the rotary support body, in which the movement mechanism moves the plurality of rollers toward the tire member in a synchronized manner so that the tire member is disposed between the plurality of rollers and the rotary support body while bringing the rollers into contact with at least one of the rotary support body and the tire member supported by the rotating rotary support body, and in which the rotary support body is contracted in a state where the tire member is disposed between the plurality of rollers and the rotary support body so that the tire member is delivered from the rotary support body to the plurality of rollers.

Further, a tire member extraction method of the invention is a tire member extraction method for extracting a ring-shaped tire member supported by an outer peripheral surface of an expandable and contractible rotary support body from the rotary support body, the tire member extraction method including: moving a plurality of rollers toward the tire member in a synchronized manner so that the tire member is disposed between the plurality of rollers and the rotary support body while bringing the rollers into contact with at least one of the rotary support body and the tire member supported by the rotating rotary support body; and delivering the tire member from the rotary support body to the plurality of rollers by contracting the rotary support body while the tire member is disposed between the plurality of rollers and the rotary support body.

### BRIEF DESCRIPTION OF THE DRAWINGS

FIG. 1 is a schematic configuration diagram of a bead manufacturing device including a tire member extraction device according to an embodiment of the invention;

FIG. 2 is a diagram illustrating an operation of the bead manufacturing device of FIG. 1;

FIG. 3 is a diagram illustrating an operation of the bead manufacturing device of FIG. 1;

FIG. 4 is a diagram illustrating an operation of the bead manufacturing device of FIG. 1;

FIG. 5 is a schematic plan view illustrating a main part of the tire member extraction device of FIG. 1;

FIG. 6 is a cross-sectional view taken alone a line A-A of FIG. 5;

FIG. 7 is a diagram illustrating an operation of the bead manufacturing device of FIG. 1; and

FIG. 8 is a schematic plan view illustrating a main part of a tire member extraction device according to a modified example of the invention.

### DETAILED DESCRIPTION OF THE INVENTION

Hereinafter, an embodiment of the invention will be described with reference to the drawings.

A tire member extraction device 10 according to the embodiment is a device which extracts a ring-shaped tire member manufactured on an outer peripheral surface of a rotary support body 2 by a bead manufacturing device 1.

The bead manufacturing device 1 includes the rotary support body 2, a chuck portion 3, a pressing roller 4, and a cutter 5. The bead manufacturing device 1 manufactures a ring-shaped tire member (bead core) C in which a bead wire BW obtained by coating a metallic wire by rubber is wound on the outer peripheral surface of the rotary support body 2.

The rotary support body 2 is a cylindrical molding drum which is divided into a plurality of segments 2a on the circumference and is expandable and contractible. The rotary support body 2 is provided to be rotatable with the rotation of a rotary shaft 2b. The rotary support body 2 can adjust a rotation angle at the time of winding the bead wire BW by a driving source such as a servomotor.

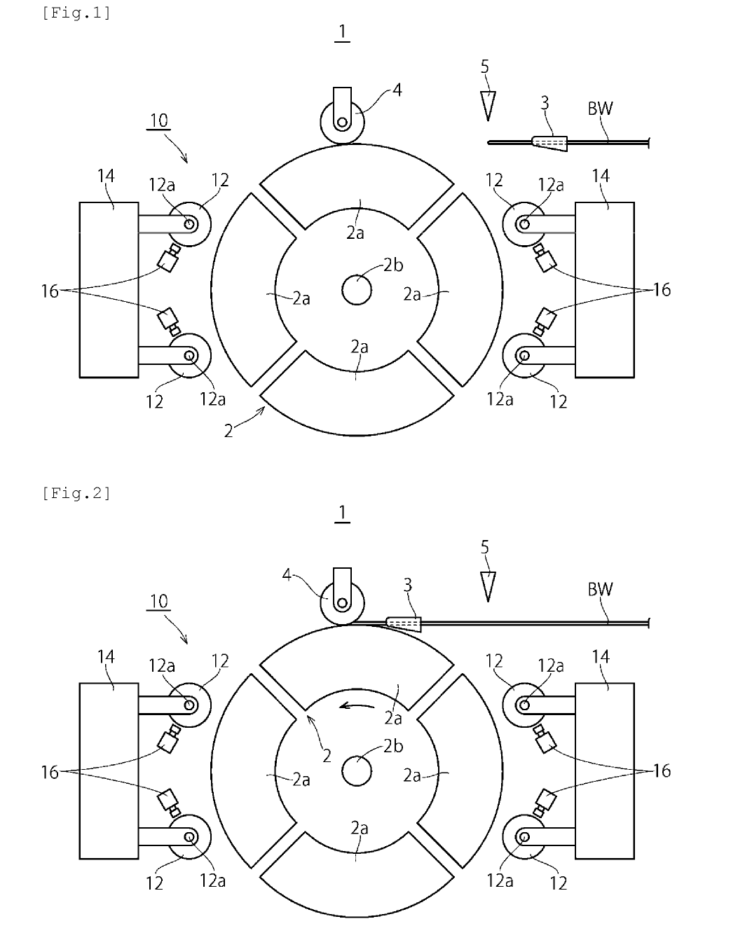

The chuck portion 3 is movable between a retracted position (see FIG. 1) separated from the rotary support body 2 and an affixed position (see FIG. 2) in the vicinity of an outer peripheral surface of the rotary support body 2 by a movement mechanism (not illustrated). The chuck portion 3 moves from the retracted position toward the affixed position while holding the end of the bead wire BW, supplies the end of the bead wire BW to a gap between the outer peripheral surface of the rotary support body 2 and the pressing roller 4, and affixes the end of the bead wire BW to the outer peripheral surface of the rotary support body 2.

The pressing roller 4 winds the bead wire BW on the outer peripheral surface of the rotary support body 2 while pressing the bead wire BW affixed to the outer peripheral surface of the rotary support body 2 against the outer peripheral surface of the rotary support body 2.

The cutter 5 cuts the bead wire BW from the bead wire BW wound on the outer peripheral surface of the rotary support body 2 by a predetermined length.

The extraction device 10 includes a plurality of rollers 12 which hold a bead core C formed on the outer peripheral surface of the rotary support body 2 and a movement mechanism 14 which moves the rollers 12. As a preferred embodiment, the extraction device 10 can include a brake 16 which prohibits the rotation of the roller 12 along with the roller 12 and the movement mechanism 14.

The roller 12 is provided at a plurality of positions and desirably three or more positions with a gap therebetween in one rotary support body 2 in the circumferential direction of the rotary support body 2. The rollers 12 contact the outer peripheral surface of the bead core C formed in the rotary support body 2 at a plurality of positions with a gap therebetween in the circumferential direction to hold the bead core C. Each roller 12 is rotatably attached to a rotary shaft 12a which is parallel to the rotary shaft 2b of the rotary support body 2. The roller 12 is formed as a resinous cylindrical body and is formed of a material softer than the outer peripheral surface of the rotary support body 2.

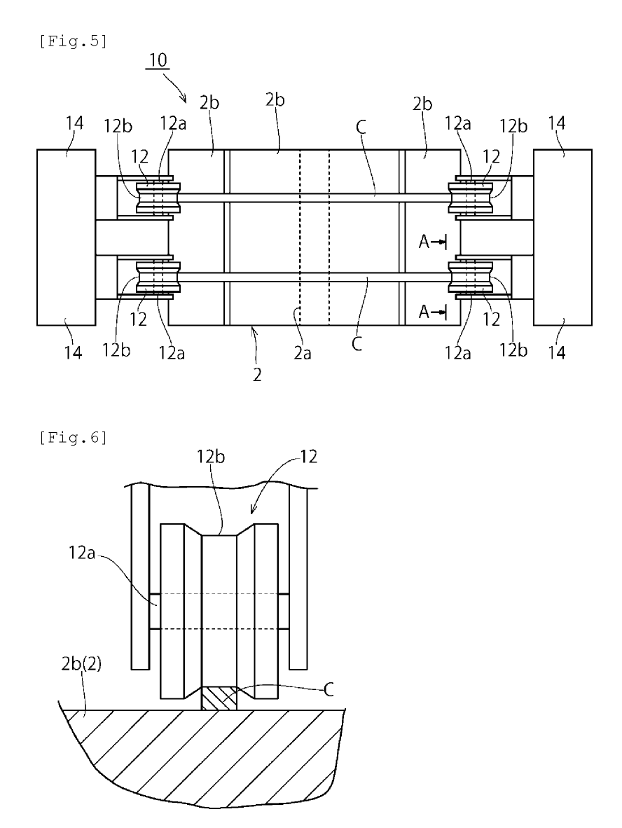

As a preferred embodiment, as illustrated in FIGS. 5 and 6, the outer peripheral surface of the roller 12 is provided with an annular concave groove 12b into which the bead core C is fitted.

Further, it is desirable to arrange the plurality of rollers 12 so that the rollers 12 are located at symmetrical positions with the rotary shaft 2b interposed therebetween when viewed from the rotary shaft 2b of the rotary support body 2 in a state where the roller 12 illustrated in FIG. 4 contacts the bead core C.

The movement mechanism 14 includes an actuator such as a cylinder. The movement mechanism 14 moves the plurality of rollers 12 toward or away from the bead core C formed on the outer peripheral surface of the rotary support body 2 in a synchronized manner.

The brake 16 includes a pad which moves toward and away from the roller 12 by the cylinder. The brake 16 allows the roller 12 to be rotatable when the pad is separated from the roller 12 and prohibits the rotation of the roller 12 when the pad contacts the roller 12. Such a brake 16 may be provided for each of the plurality of rollers 12, may be provided for a part of the plurality of rollers 12, or may be provided for only any one of the rollers 12.

Next, the operations of the bead manufacturing device 1 and the extraction device 10 will be described.

First, the chuck portion 3 moves from the retracted position illustrated in FIG. 1 toward the affixed position illustrated in FIG. 2 while holding the end of the bead wire BW in a state where the rotary support body 2 is expanded and the pressing roller 4 approaches the outer peripheral surface of the rotary support body 2 so that the front end of the bead wire BW is inserted between the outer peripheral surface of the rotary support body 2 and the pressing roller 4.

Then, when the front end of the bead wire BW is inserted between the rotary support body 2 and the pressing roller 4, the chuck portion 3 releases the holding of the bead wire BW and moves from the affixed position toward the retracted position. Subsequently, the servomotor is activated to rotate the rotary support body 2. By the rotation of the rotary support body 2, the bead wire BW is wound on the rotary support body 2 while being pressed against the pressing roller 4.

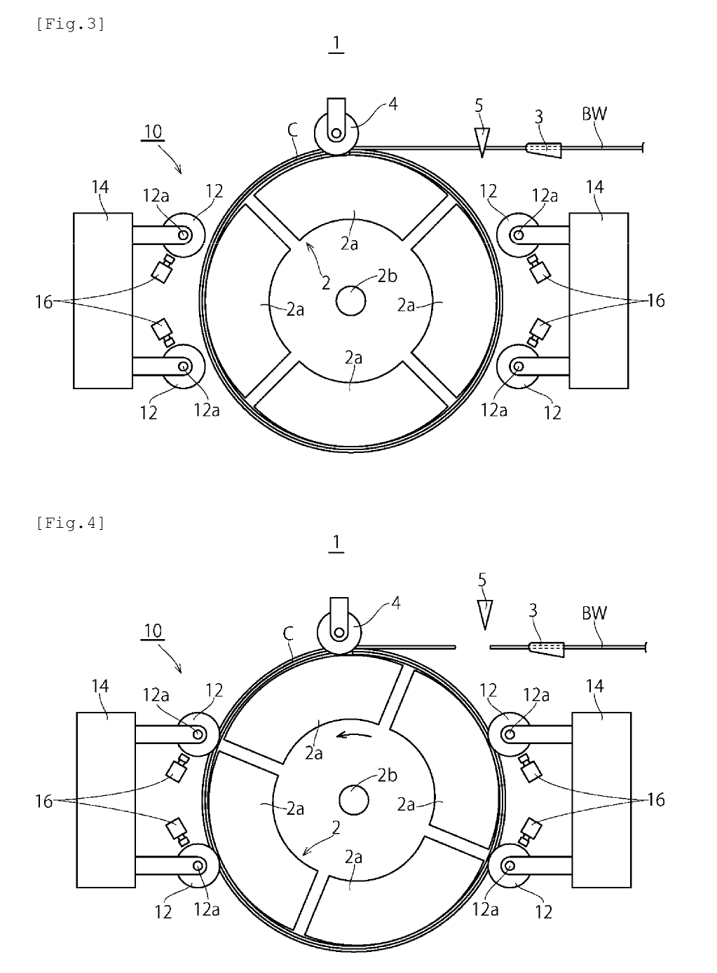

Then, when the rotary support body 2 rotates by a predetermined angle after the rotation starts, the servomotor is stopped and the winding of the bead wire BW is stopped. Then, as illustrated in FIG. 3, the bead wire BW is cut by the cutter 5 to form the rear end of the bead wire BW after the chuck portion 3 holds the bead wire BW.

Then, when the cutter 5 cuts the bead wire BW, the servomotor is activated to rotate the rotary support body 2 so that the rear end of the bead wire BW is wound on the rotary support body 2 as illustrated in FIG. 4. Further, the movement mechanism 14 of the extraction device 10 moves the plurality of rollers 12 toward the bead core C in a synchronized manner during the rotation of the rotary support body 2 and moves the plurality of rollers 12 until the outer peripheral surface of the roller 12 contacts the outer peripheral surface of the bead core C as illustrated in FIGS. 5 and 6.

In the embodiment, the bead core C is fitted into the concave groove 12b provided in the outer peripheral surface of the roller 12 and the bead core C is sandwiched between the plurality of rollers 12 and the rotary support body 2. Accordingly, the plurality of rollers 12 rotate in synchronization with the rotation of the rotary support body 2 by the friction with the bead core C.

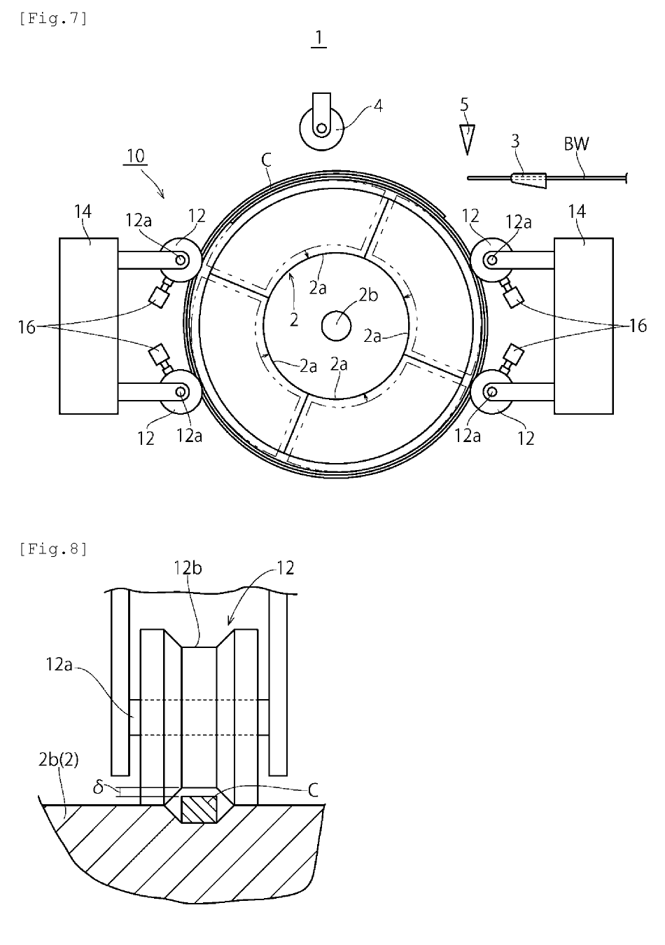

Then, as illustrated in FIG. 7, the segments 2a of the rotary support body 2 move in a contracted state while the bead core C is sandwiched between the plurality of rollers 12 and the rotary support body 2. Accordingly, the bead core C is delivered from the rotating rotary support body 2 to the plurality of rollers 12, thereby completing the extraction of the bead core C. Further, the segments 2a move in a contracted state and the pressing rollers 4 move to be separated from the outer peripheral surface of the rotary support body 2. Then, when the extraction of the bead core C is completed, the brake 16 prohibits the rotation of the roller 12 by bringing the pad into contact with the roller.

Further, in the above-described embodiment, the movement mechanism 14 of the extraction device 10 move the plurality of rollers 12 in a synchronized manner toward the bead core C so that the outer peripheral surface of the roller 12 contacts the outer peripheral surface of the bead core C. However, as illustrated in FIG. 8, in a state where the outer peripheral surface of the roller 12 is brought into contact with the outer peripheral surface of the rotary support body 2 so that a gap δ is formed between the roller 12 and the bead core C, the bead core C may be disposed between the roller 12 and the rotary support body 2 or the outer peripheral surface of the roller 12 may be brought into contact with both the outer peripheral surface of the rotary support body 2 and the bead core C.

In a state illustrated in FIG. 8 in which the outer peripheral surface of the roller 12 contacts the outer peripheral surface of the rotary support body 2 so that the gap δ is formed between the roller 12 and the bead core C, the plurality of rollers 12 rotate in synchronization with the rotation of the rotary support body 2 by the friction with the rotary support body 2. Then, when the segments 2a of the rotary support body 2 move in a contracted state from this state, the plurality of rollers 12 move toward the bead core C by a distance corresponding to the gap δ formed between the roller 12 and the bead core C in synchronization with the movement of the segments 2a in a contracted state. Accordingly, the bead core C is delivered from the rotating rotary support body 2 to the plurality of rollers 12 so that the bead core C can be extracted from the rotary support body 2.

Further, in the embodiment, a case in which the ring-shaped tire member extracted from the outer peripheral surface of the rotary support body 2 is the bead core C has been described, but the invention is not limited thereto. For example, the invention can be also applied to a cylindrical casing and a green tire obtained by bonding a plurality of tire members in an unvulcanized state so that a tire member other than the bead core C is extracted from the rotary support body.

In the above-described embodiment, since the plurality of rollers 12 are brought into contact with at least one of the bead core C and the rotary support body 2, the rollers 12 are rotated in synchronization with the rotation of the rotary support body 2, and the rotary support body 2 is contracted so that the bead core C is delivered from the rotary support body 2 to the roller 12, the bead core C can be extracted from the rotating rotary support body 2 and thus the manufacturing time can be shortened.

Further, in the embodiment, since the brake 16 which prohibits the rotation of the roller 12 is provided, the bead core C held by the roller 12 does not rotate accidentally.

Further, in the embodiment, since the outer peripheral surface of the roller 12 holding the bead core C is provided with the concave groove 12b into which the bead core C is fitted, it is possible to prevent a problem in which the bead core C held by the roller 12 moves in the direction of the rotary shaft 12a and falls from the roller 12.

While the embodiment of the invention has been described, the embodiment is merely an example and does not limit the scope of claims. The novel embodiment can be implemented in various modes and various omissions, replacements, and modifications can be made without departing from the spirit of the invention.

What is claimed is:

1. A tire member extraction device for extracting a ring-shaped tire member supported by an outer peripheral surface of an expandable and contractible rotary support body from the rotary support body, the tire member extraction device comprising:
a plurality of rollers; and
a movement mechanism which moves the plurality of rollers toward and away from the tire member supported by the rotary support body,
wherein the movement mechanism moves the plurality of rollers toward the tire member in a synchronized manner so that the tire member is disposed between the plurality of rollers and the rotary support body while bringing the rollers into contact with at least one of the rotary support body and the tire member supported by the rotary support body, and
wherein the rotary support body is contracted in a state where the tire member is disposed between the plurality of rollers and the rotary support body so that the tire member is delivered from the rotary support body to the plurality of rollers.

2. The tire member extraction device according to claim 1, further comprising:
a brake which prohibits the rotation of the plurality of rollers.

3. The tire member extraction device according to claim 1,
wherein an outer peripheral surface of the roller is provided with a concave groove into which the tire member is fitted.

4. The tire member extraction device according to claim 1,
wherein the roller is provided at three or more positions.

5. The tire member extraction device according to claim 2,
wherein an outer peripheral surface of the roller is provided with a concave groove into which the tire member is fitted.

6. The tire member extraction device according to claim 2,
wherein the roller is provided at three or more positions.

7. A tire member extraction method for extracting a ring-shaped tire member supported by an outer peripheral surface of an expandable and contractible rotary support body from the rotary support body, the tire member extraction method comprising:
moving a plurality of rollers toward the tire member in a synchronized manner so that the tire member is disposed between the plurality of rollers and the rotary support body while bringing the rollers into contact with at least one of the rotary support body and the tire member supported by the rotating rotary support body; and
delivering the tire member from the rotary support body to the plurality of rollers by contracting the rotary support body while the tire member is disposed between the plurality of rollers and the rotary support body.

8. The tire member extraction method according to claim 7,
wherein the rotation of the plurality of rollers is prohibited after the tire member is delivered from the rotary support body to the plurality of rollers.

9. The tire member extraction method according to claim 7,
wherein the plurality of rollers hold the tire member at a position of a concave groove provided in an outer peripheral surface.

10. The tire member extraction method according to claim 7,
wherein the tire member is held by using three or more rollers.
